(19) United States
(12) Patent Application Publication
(10) Pub. No.: US 2024/0354827 A1
(43) Pub. Date: Oct. 24, 2024

(54) SYSTEM AND METHOD FOR GENERATING PRODUCT SPECIFIC QUESTIONS

(71) Applicant: Klevu Oy, Espoo (FI)

(72) Inventors: Niraj Aswani, St Albans (GB); Nilay Oza, London (GB)

(21) Appl. No.: 18/639,869

(22) Filed: Apr. 18, 2024

Related U.S. Application Data
(60) Provisional application No. 63/496,857, filed on Apr. 18, 2023.

(51) Int. Cl. G06Q 30/0601; G06F 3/16; G06F 16/332; G06F 16/338; G10L 15/22

(52) U.S. Cl. CPC G06Q 30/0625; G06F 3/167; G06F 16/3329; G06F 16/338; G10L 15/22

(57) ABSTRACT

Disclosed herein is a system and method for enhancing online shopping experiences through a personalized product discovery platform implemented on an eCommerce platform. This system comprises a memory that stores instructions alongside product data such as attributes, ratings, and user reviews. A processor, configured to execute these instructions, dynamically generates product-specific questions for each user query to facilitate deeper user engagement. The system adapts its questioning and search algorithms based on user responses, enabling a more tailored shopping experience. Additionally, it updates the product database in real-time, reflecting changes based on user interactions and preferences. This innovative approach utilizes advanced machine learning and natural language processing technologies to interpret user inputs and refine interactions, thus offering a more intuitive and personalized user interface. This method significantly improves the accuracy of product recommendations, making online shopping more efficient and user-friendly.

### TECHNICAL FIELD

The present invention relates generally to online ecommerce and specifically to system and method for generating product specific questions.

### BACKGROUND

The rise of eCommerce has transformed the shopping experience by offering unparalleled convenience, 24/7 accessibility, a wider variety of products, and personalized recommendations that cater to individual preferences, making it easier than ever to find and purchase exactly what you're looking for. eCommerce platforms use data and algorithms to personalize the shopping experience for each individual, offering tailored product recommendations and personalized marketing messages that cater to specific interests and preferences. All of these factors have contributed to the rapid rise and continued growth of eCommerce as a dominant force in the retail industry. However, despite of this, customers are often faced with purchase decision dilemmas and not very sure of what they want to buy. Large number of options and varieties only add to this undecisive behaviour. Compared to shopping experience in physical brick & mortar store, customers are used to assistance by a store agent/assistant who helps them with the shopping decision by asking relevant questions in relation to a subject product or category which the customers intend to purchase.

Due to the abovementioned undecisive behaviour of the user on account of choice overload, current online shopping experiences rely heavily on the user entering precise search terms and using filters to find desired products. This method can be cumbersome and may not effectively use rich product data to assist users in discovering products that meet their specific needs. Further, this leads to excessive processing power being wasted and yet the user unable to find the desired items.

In light of the above-mentioned problems associated with existing methods and systems for online commerce and user shopping experience, it is highly desirable to have a system and method for providing assistance to a user in purchasing a product by offering relevant questions and subsequently incorporating user preferences and choices in the search results, thereby minimizing the number of processing computations required for the desired search results.

### SUMMARY

Embodiments of the present disclosure present technological improvements as solutions to one or more of the above-mentioned technical problems recognized by the inventor in conventional solutions.

The invention provides a conversational AI that mimics the helpful presence of a store assistant by dynamically generating specific questions that guide the user through their shopping experience. One or more questions are generated in real time in order and the user response to said questions helps in refining search results and recommendations, thereby addressing user intent more accurately and making the shopping process more intuitive and user-friendly.

Additional aspects, advantages, features and objects of the present disclosure would be made apparent from the drawings and the detailed description of the illustrative embodiments construed in conjunction with the complete specification that will follow.

It will be appreciated that features of the present disclosure are susceptible to being combined in various combinations without departing from the scope of the present disclosure.

### BRIEF DESCRIPTION OF DRAWINGS

The summary above, as well as the following description of illustrative embodiments are better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 depicts a block diagram of a system as per the disclosed invention.

FIG. 2 is a flowchart depicting method steps as per the present invention

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DESCRIPTION OF EMBODIMENTS

The following description illustrates embodiments of the present disclosure and ways in which they can be implemented. Although some modes of carrying out the present disclosure have been disclosed, those skilled in the art would recognize that other embodiments for carrying out or practicing the present disclosure are also possible.

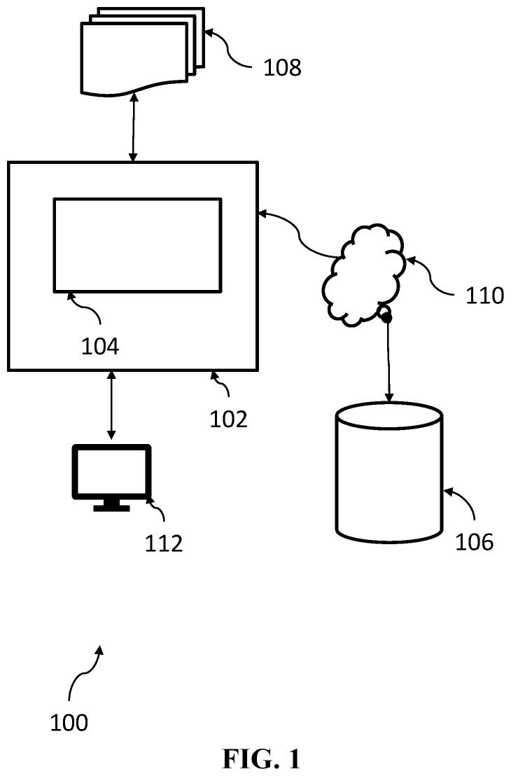

The system 100 as disclosed herein comprises a processor 102 communicably coupled to a memory 108 that stores one or more large language model based Generative AI modules. The processor 102 further comprises a conversational agent 104 and is connected to a data repository 106. Throughout the disclosure the term “conversational agent” refers to a software module functionally operable to output text/audio response on basis of an input prompt from a user interacting with the ecommerce platform. The processor 102, through the conversational agent 104, guides users through a personalized shopping experience by dynamically generating and managing interactive questions on a user interface 112, based on real-time data analysis. FIG. 1 depicts a block diagram of the system 100.

As in case of any ecommerce platform operation, the user enters a search query. The search query is parsed, and a plurality of search results are generated for further analysis of the user. Each of the plurality of search results relate to a distinct product listed on the ecommerce platform. The search results are presented to the user on a user interface 112. The user selects atleast one product from the plurality of search results presented pursuant to the search query.

The processor 102 is operable to receive a user input corresponding to atleast one of the plurality of search results retrieved pursuant to the search query on the eCommerce platform. The user input may relate to selecting one of the product or taking any other action on the user interface 112 in relation to the said product. Other such action may relate to like, save or other such contextual action related to the product. The user input pertains to user's focus or interest on a specific product. The processor 102 is further configured to invoke the conversational agent 104 and communicate the said user input to the conversation agent.

In an embodiment of the present invention, user input is facilitated via voice commands, utilizing advanced speech recognition technology. Users can verbally communicate with the conversational agent, providing inputs such as product queries or navigation instructions. The processor captures these audio inputs through integrated microphones, processes the audio to reduce noise and enhance clarity, and then employs speech recognition algorithms to convert the spoken words into text. This text is subsequently analyzed to interpret the user's intent and generate appropriate responses or questions, thereby enabling a seamless, hands-free shopping experience that mimics natural human conversation and enhances user accessibility and convenience.

The processor 102, upon receiving the user input, processes the user input selected product or products to understand key attributes or areas where the user might need more information. accesses stored data from the data repository 106 relevant to the selected product or products. This data encompasses a wide range of information including, but not limited to, product catalogue data including product attributes (such as size, color, material, etc.), customer reviews, product ratings, and other metadata which could influence user decision-making. The processor 102 employs artificial intelligence based algorithms to analyse this data and extract meaningful insights about what additional information the user might require or what specific product features are drawing the user's interest. The processor analyzes the user input and the accessed data to determine the context of the user's queries or selections.

Based on the said analysis, the processor 102 determines key areas where the user may need further information or clarification. This could involve identifying commonly questioned aspects of a product, such as its durability or compatibility with other devices, or understanding the concerns reflected in customer reviews. The processor generates one or more questions that are product specific and are specifically designed to address the user's potential concerns or provide comparative insights that aid in decision-making.

In order to generate the product specific questions for a given product in the search results, the processor 102 utilizes information that has been provided to the ecommerce platform in relation to the product such as product titles, attributes (e.g., colour, size, material, price etc), descriptions, ratings and reviews, products' analytics history etc.

The processor 102 utilizes a set of predefined algorithms designed to analyze the user input in conjunction with relevant product data. The set of predefined algorithms includes components of natural language processing to understand the intent and content of the user's input, as well as data mining techniques to extract pertinent information from a large dataset of product information.

The processor 102 analyzes the historical search data of users to identify patterns and frequently searched terms or categories that helps in understanding what aspects of said product are most important to the shoppers, such as price sensitivity, brand preference, or specific product features. The processor is further operable to process data pertaining to product reviews for opinions and sentiments expressed by other users about various aspects of products and services. It identifies common themes, praises, or complaints and provide additional information on these commonly highlighted areas, such as durability concerns or performance under certain conditions. The processor further analyzes the content and context of questions previously asked by other users in relation to said product. This involves understanding the types of information users frequently seek and their typical concerns regarding specific types of products. Using this data, the processor prioritizes most contextual questions to be generated.

The one or more questions generated are specifically tailored to the context of the user's input on selected product. For example, if the user has shown interest in a particular type of product but has not specified a certain attribute like size or color, the processor may generate questions to ascertain the user's preferences in these areas. The one or more questions are designed to clarify the user's needs, provide additional information that might be pertinent based on the user's interaction with the ecommerce platform, or help narrow down choices by highlighting key differentiators among products. This results in lesser number of search queries and operations by the user in finding relevant product.

The processor 102 is operable to generate the set of product specific questions for a given search result only when there is a positive answer for the generated product specific question. As an example case, for a give search result P0, the processor 102 shall certainly have the answer for a generated question Q1, although the processor might not have the same answer for the search result P1 for the same generated question Q1. This means that question Q1 shall not be generated in context of search result P1. Questions such as “Compare two product search results” would be generated by the processor 102 only when the processor 102 has sufficient information about both the product search results and can output the comparison.

In yet another aspect of the present invention, one or more large language models based generative AI modules are used to generate one or more questions by the processor 102 for the given product.

It shall be appreciated by person skilled in the art that the processor is operable to generate the one or more questions in real time and dynamically. This results in change of the one or more questions in case the user selects another product.

The processor 102 is operable to present the list of one or more generated questions on the user interface 112 for further user interaction. The presentation can be in various formats—textual on a screen, spoken through a voice assistant, or even visually represented in augmented or virtual reality settings.

In yet another embodiment of the present invention, the processor is configured to intelligently interpret a user's selection from a list of search results on the eCommerce platform. When a user selects a specific product, the agent employs natural language processing (NLP) to analyze the product's detailed attributes-such as specifications, descriptions, and reviews-available within the search results. The system contextualizes this selection by comparing it with other products in the list or with historical data on user interactions related to similar products. Based on this analysis, the agent generates targeted follow-up questions that aim to clarify the user's specific interests or concerns about the selected product. For instance, if a user selects a laptop, the agent might generate questions like “Are you interested in learning more about the battery life or the graphic capabilities of this model?” or “Would you like to compare this model with others that have a similar price range?” This process ensures that the questions are directly relevant to the user's selection, helping to refine their choices and assist in making a more informed purchase decision.

In another aspect, the user is able to assess the one or more generated questions that would help in purchase decision making and clarifying questions about the product. The user can further provide response to the one or more questions. Once the user responds to the questions, the processor processes these responses to understand the user's answers and their implications for search preferences. Based on the processed responses, the processor adjusts the search results by re-ranking products, filtering out items that don't meet newly clarified criteria, or highlighting features that align with the user's preferences. The modification of search results is dynamic, allowing for real-time updates to the user's query results. As the user continues to interact with the processor, further adjustments can be made, refining the search results progressively to shortlist the most relevant products.

In yet another embodiment, the processor, through the conversational agent, is further configured to generate follow-up questions based on the user's initial responses to the one or more generated questions.

Optionally, the processor 102 can incorporate a feedback mechanism where the effectiveness of the modified search results is evaluated based on further user interactions, such as clicks, purchases, or additional queries. This feedback is used to continuously improve the modified search results.

In yet another embodiment, the conversational agent enhances the decision-making process for users contemplating multiple product options by suggesting comparative questions. When the system detects that a user is viewing or comparing several products, it leverages its understanding of product attributes and user preferences to generate targeted questions that highlight key differences. For instance, if a user is comparing two smartphones, the conversational agent might ask, “Would you prefer a phone with a longer battery life or better camera quality?” This functionality not only aids users in making more informed choices by focusing on critical product features and benefits but also streamlines the shopping experience by reducing decision fatigue and providing clarity in complex purchasing scenarios.

The processor 102 leverages use of adaptive UIs and dynamic response systems which represents significant improvements over static search interfaces, allowing eCommerce platforms to offer a more personalized interactive user interface.

In another embodiment, the processor employs machine learning (ML) algorithms to adaptively refine the process of generating questions. This adaptive refinement is based on the analysis of accumulated user response data, which ensures that the questions become increasingly relevant and accurate over time, thereby improving the effectiveness of generated questions and user satisfaction. The processor collects data from user responses to previously generated questions. This includes direct answers, behavioral data (e.g., which questions led to longer interactions or higher engagement), and subsequent actions (such as purchases made after certain questions were asked). Besides direct responses, the processor also gathers contextual data regarding the circumstances under which questions were asked, including time, user demographics, and product specifics. Collected data are aggregated and categorized based on various parameters such as question type, user demographics, and interaction outcomes. One or more machine learning algorithms analyze these datasets to identify patterns and trends that indicate how different types of questions influence user decisions and engagement. Using the identified patterns, machine learning models are trained to predict the effectiveness of different types of questions in various contexts. This training process uses historical data to improve the models' predictive accuracy. The processor implements continuous or incremental learning processes, where the ML models are periodically updated with new data to refine their predictive capabilities and adjust to changing user preferences and market trends. Leveraging the insights from the machine learning models, the processor dynamically adjusts its question generation algorithms. This can involve changing the types of questions asked, the timing of the questions during an interaction, or the specificity of the questions based on the user's profile and past responses. Questions are increasingly personalized for users based on the learned preferences, improving relevance and the likelihood of positive user engagement.

By refining the generation of questions through machine learning based on accumulated user response data, the processor 102 can more accurately predict and address user needs. This reduces the need for users to conduct multiple, broad, or unfocused searches that typically require more computational resources to process. Enhanced question accuracy ensures that the search engine retrieves more relevant results on the first attempt. This minimizes the need for repeated searches and reduces the volume of data processed and transferred, thereby decreasing the computational load.

Moreover, improved question relevance means that fewer queries may reach the server for processing, as users find what they need more quickly. This reduces server load and can contribute to lower power consumption, as data centres consume significant energy primarily for power and cooling. With more predictable user queries and behaviors, caching mechanisms can be optimized to store and retrieve data more efficiently. Frequently accessed data based on common queries identified through machine learning can be cached more strategically, reducing the time and energy needed to fetch data from primary storage. By streamlining the number of necessary computations, the processor requires less energy to operate at an optimal level. This is especially beneficial for large-scale eCommerce platforms, where slight efficiencies in search algorithms can lead to significant reductions in overall energy consumption.

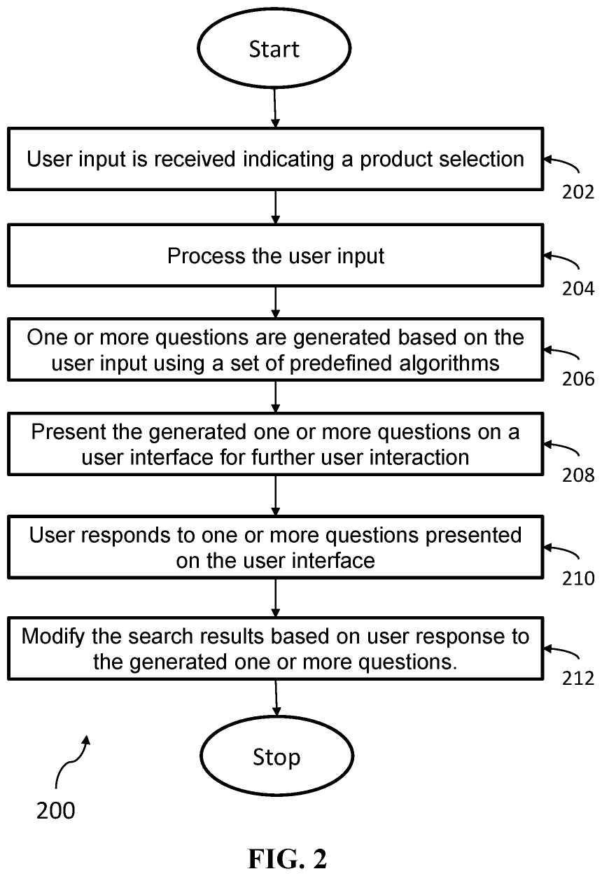

FIG. 2 is a flowchart depicting method steps 200 as per the present invention. At step 202, the user input is received indicating a product selection. At step 204, the processor processes the user input. At step 206, one or more questions are generated based on the user input using a set of predefined algorithms. Further at step 208, the generated one or more questions are presented on a user interface for further user interaction. At step 210, the user responds to one or more questions presented on the user interface. At step 212, the processor modifies the search results based on user response to the generated one or more questions.

Method steps of the invention may be performed by one or more computer processors executing a set of non-transitory machine readable instructions tangibly embodied on a computer-readable medium to perform functions of the invention. Suitable processors include, by way of example, both general and special purpose microprocessors. Generally, the processor receives (reads) computer executable instructions and data from a memory (such as a read-only memory and/or a random-access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays).

One or more components of the invention are described as unit for the understanding of the specification. For example, a unit may include self-contained component in a hardware circuit comprising of logical gate, semiconductor device, integrated circuits or any other discrete component. The unit may also be a part of any software programme executed by any hardware entity for example processor. The implementation of unit as a software programme may include a set of logical instructions to be executed by a processor or any other hardware entity.

Additional or less units can be included without deviating from the novel art of this disclosure. In addition, each unit can include any number and combination of sub-units, and systems, implemented with any combination of hardware and/or software units.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

Any examples or illustrations given herein are not to be regarded in any way as restrictions on, limits to, or express definitions of, any term or terms with which they are utilized. Instead, these examples or illustrations are to be regarded as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms.

The description, embodiments and figures are not to be taken as limiting the scope of the claims. It should also be understood that throughout this disclosure, unless logically required to be otherwise, where a process or method is shown or described, the steps of the method may be performed in any order, repetitively, iteratively or simultaneously. At least portions of the functionalities or processes described herein can be implemented in suitable computer-executable instructions.

It will be appreciated that features of the present disclosure are susceptible to being combined in various combinations and additional features may be introduced without departing from the scope of the present disclosure.

1. A computer-implemented method for enhancing user interaction in an eCommerce platform, comprising:
receiving a user input corresponding to atleast one of a plurality of search results retrieved pursuant to a search query on an eCommerce platform;
processing the user input through a conversational agent;
generating one or more questions based on the user input and a set of predefined algorithms;
presenting the one or more generated questions to the user through a user interface; and
pursuant to a response to the one or more generated questions, modifying search results based on responses to the generated questions.

2. The method of claim 1, wherein generating one or more further includes employing natural language questions processing to interpret the user input in context of retrieved search results.

3. The method of claim 1, wherein the set of predefined algorithms include one or more machine learning models that adapt based on accumulated user response data to improve the relevance and accuracy of the questions over time.

4. The method of claim 1, wherein the user input is received via voice command, and the conversational agent is further configured to process spoken language using speech recognition technology.

5. The method of claim 1, wherein modifying search results includes filtering the results to highlight products that match specific attributes identified as priorities in the user's responses.

6. The method of claim 1, wherein the conversational agent is further configured to generate follow-up questions based on the user's initial responses.

7. The method of claim 1, further comprising a feedback mechanism wherein the user can rate the relevance of the questions presented, which the conversational agent uses to refine future interactions for all users on the e-commerce platform.

8. The method of claim 1, wherein the conversational agent is capable of suggesting comparative questions if the user is considering multiple products, to assist in differentiating between product options.

9. A system for personalized product discovery on an eCommerce platform, comprising:
a memory storing instructions and product data including attributes, ratings, and user reviews;
a processor configured to execute instructions stored in the memory, wherein the processor is operable to:
receive a user input corresponding to atleast one of a plurality of search results retrieved pursuant to a search query on an eCommerce platform;
process the user input through a conversational agent;
generate one or more questions based on the user input and a set of predefined algorithms;
present the one or more generated questions to the user through a user interface; and
pursuant to a response to the one or more generated questions, modify search results based on responses to the generated questions.

10. The system of claim 9, wherein the processor, for generating one or more questions, employs natural language processing to interpret the user input in context of retrieved search results.

11. The system of claim 9, wherein the set of predefined algorithms include machine learning models that adapt based on accumulated user response data to improve the relevance and accuracy of the questions over time.

12. The system of claim 9, wherein the user input is received via voice command, and the conversational agent is further configured to process spoken language using speech recognition technology.

13. The system of claim 9, wherein the processor is further operable to modify search results by filtering the results to highlight products that match specific attributes identified as priorities in the user's responses.

14. The system of claim 9, wherein the processor is further configured to generate follow-up questions based on the user's initial responses.

15. The system of claim 9, further comprising a feedback mechanism wherein the user can rate the relevance of the questions presented.

16. The system of claim 1, wherein the conversational agent is capable of suggesting comparative questions if the user is considering multiple products, to assist in differentiating between product options.
